(19) United States
(12) Patent Application Publication
(10) Pub. No.: US 2016/0309958 A1
(43) Pub. Date: Oct. 27, 2016

(54) IMPROVEMENTS IN OR RELATING TO LIQUID-BASED COOKING APPARATUSES

(71) Applicant: FLUID-O-TECH, SRL, Milano (IT)

(72) Inventor: Paul Williams, Edwinstowe (GB)

(21) Appl. No.: 15/106,047

(22) PCT Filed: Dec. 19, 2014
(86) PCT No.: PCT/GB2014/053790

§ 371 Date: Jun. 17, 2016

(30) Foreign Application Priority Data
Dec. 21, 2013 (GB) 1322820.0
Feb. 21, 2014 (GB) 1403092.8

(51) Int. Cl. A47J 37/12; B01D 35/28

(52) U.S. Cl. CPC A47J 37/1223; B01D 35/28

(57) ABSTRACT

A cleaning device (10), for a liquid-based cooking apparatus (68), comprises a cleaning body (12). The cleaning body (12) includes an inlet (14) to receive debris-contaminated cooking liquid (16). The inlet (16) has an inlet aperture (18) from which extends an inlet guide (20). The inlet guide (20) narrows towards the inlet aperture (18) to in use urge debris-contaminated cooking liquid (16) through the inlet aperture (18). The cleaning body (12) also includes a cleaning chamber (26) that is arranged on a downstream side (28) of the inlet aperture (18) to separate debris (30A, 30B) from debris-contaminated cooking liquid (16) urged thereinto by the inlet guide (20).

This invention relates to a cleaning device for a liquid-based cooking apparatus, and to a method of cleaning a liquid-based cooking apparatus using such a cleaning device.

A liquid-based cooking apparatus uses cooking liquids, typically in the form of oils or fats, to cook food items, with a particular type of such a cooking apparatus being a deep fat fryer. In each instance the cooking apparatus includes a cooking receptacle, such as a tank, bath or other vessel, which in use receives and retains the aforementioned cooking liquid during and after cooking.

During previous cooking sessions debris breaks free from the food items whereupon it sinks towards the bottom of the cooking receptacle and, depending on its size and density, either remains suspended within the cooking liquid in a lower region of the cooking receptacle or comes to rest on the bottom of the cooking receptacle. Such debris thereafter continues to cook within the cooking liquid such that it is completely overcooked and thereby adopts an essentially blackened, i.e. carbonised, appearance and associated foul taste.

The resulting debris contaminates the cooking liquid such that in a subsequent cooking session the debris suspended within the cooking liquid adheres to new food items placed in the cooking liquid, while denser debris items are driven from the bottom of the cooking receptacle whereby they too adhere to the newly-placed food items.

As a result the subsequently cooked food items emerge from the cooking liquid with blackened debris adhered to their outer surfaces. This is undesirable from both an aesthetic and taste perspective.

According to a first aspect of the invention there is provided a cleaning device, for a liquid-based cooking apparatus, comprising a cleaning body including:
an inlet to receive debris-contaminated cooking liquid, the inlet having an inlet aperture from which extends an inlet guide, the inlet guide narrowing towards the inlet aperture to in use urge debris-contaminated cooking liquid through the inlet aperture; and
a cleaning chamber arranged on a downstream side of the inlet aperture to separate debris from debris-contaminated cooking liquid urged thereinto by the inlet guide.

The inclusion of an inlet guide that narrows towards the inlet aperture to, in use, urge debris-contaminated cooking liquid through an inlet aperture increases the velocity of the debris-contaminated cooking liquid as it is forced through the inlet aperture which helps to ensure that debris suspended in the cooking liquid is carried through the inlet aperture to the cleaning chamber lying therebeyond.

In addition, increasing the velocity of the debris-contaminated cooking liquid in the foregoing manner dislodges and entrains debris, such as larger debris items which may be lying on the bottom of a cooking receptacle within a cooking apparatus, within the flow of debris-contaminated cooking liquid urged through the inlet aperture and into the cleaning chamber.

The invention thereby helps to facilitate complete cleaning of the cooking apparatus, i.e. the complete removal of debris from the cooking fluid used by the cooking apparatus, without, e.g. the need to drain or otherwise remove debris-contaminated cooking liquid from the cooking apparatus.

Preferably the inlet guide extends completely around the inlet aperture.

The foregoing arrangement helps to maximise the area over which the inlet guide is effective in dislodging and entraining debris within the flow of debris-contaminated cooking liquid urged into the cleaning chamber.

The inlet guide may extend symmetrically around the inlet aperture.

Having the inlet guide extend symmetrically around the inlet aperture helps to ensure that its ability to dislodge and entrain debris within the flow of debris-contaminated cooking liquid urged into the cleaning chamber is uniformly distributed across the inlet guide, so as to assist in providing a substantially uniform cleaning effect across, e.g. the bottom of a cooking receptacle within a cooking apparatus.

Optionally the inlet aperture and cleaning chamber cooperate with one another to resist the flow of debris-contaminated cooking liquid from the downstream side of the inlet aperture to an upstream side thereof.

Such an arrangement helps to ensure the debris-contaminated cooking liquid can be directed to a region of the cleaning chamber that separates debris therefrom, rather than the debris-contaminated cooking liquid flowing back out of the cleaning device.

In a preferred embodiment of the invention the cleaning chamber includes a discharge guide having a first end lying coincident with the inlet aperture, the discharge guide extending away from the inlet aperture and towards the upstream side of the inlet aperture to define a second end of the discharge guide.

The inclusion of a discharge guide that extends both away from the inlet aperture and towards the upstream side of the inlet aperture helps to capture and retain the debris-contaminated cooking liquid that is urged through the inlet aperture and into the cleaning chamber.

Such a discharge guide also directs the said captured debris-contaminated cooking liquid to a region of the cleaning chamber that separates debris from the debris-contaminated cooking liquid.

Preferably the discharge guide extends completely around the inlet aperture.

Having the discharge guide extend completely around the inlet aperture helps to maximise the region of the associated cleaning chamber that is available to separate debris from the debris-contaminated cooking liquid urged threreinto.

Optionally the discharge guide extends symmetrically around the inlet aperture.

Such an arrangement provides for a substantially uniform distribution of separated debris within the cleaning chamber and so helps to maximise the amount of separated debris the cleaning chamber is able to retain for a given size of cleaning chamber.

The second end of the discharge guide may define a rectangular perimeter.

Having the second end of the discharge chamber define a rectangular perimeter allows the cleaning device to envelop the whole of, e.g. the bottom of a cooking receptacle in a cooking apparatus, and thereby effect cleaning across the said whole area.

In another preferred embodiment of the invention a first side of a body member defines the inlet guide and a second side of the body member defines the discharge guide.

Such an arrangement simplifies the manufacture of the cleaning device while at the same time helping to ensure the cleaning device has space-efficient dimensions.

Optionally the body member is or includes a planar member.

Having the body member be or include a planar member further helps the cleaning device adopt compact and space-efficient proportions.

The planar member may be formed from a plurality of planar member panels.

The inclusion of a plurality of planar member panels provides for a good deal of flexibility in terms of the range of shapes that the planar member can adopt without unduly decreasing the ease with which the resulting body member can be manufactured.

Preferably the cleaning chamber includes a filter member arranged towards the second end of the discharge guide.

The inclusion of a filter member desirably catches debris entrained within the debris-contaminated cooking liquid urged into the cleaning chamber, thereby removing the said debris and leaving substantially uncontaminated, i.e. substantially clean cooking liquid, to flow on out of the cleaning device.

In a further preferred embodiment of the invention the filter member is or includes a mesh upstanding from the discharge guide.

An upstanding mesh is able to cooperate with the discharge guide to create a trap for debris while readily permitting the remaining cooking fluid to pass therethrough essentially unhindered.

According to a second aspect of the invention there is provided a method of cleaning a liquid-based cooking apparatus including a cooking receptacle that in use receives and retains a cooking liquid, comprising the steps of:
(a) inserting a cleaning device according to any preceding claim into the cooking receptacle with the inlet guide of the cleaning device extending below the inlet aperture;
(b) driving debris-contaminated cooking liquid towards the inlet guide whereby the inlet guide urges the debris-contaminated cooking liquid through the associated inlet aperture; and
(c) separating in a cleaning chamber of the cleaning device debris from debris-contaminated cooking liquid urged into the cleaning chamber by the inlet guide.

The method of the invention shares the benefits associated with the corresponding features of the cleaning device recited hereinabove.

Preferably the step (b) of driving debris-contaminated cooking liquid towards the inlet guide includes increasing the temperature of the cooking liquid.

Increasing the temperature of the cooking liquid causes warmer debris-contaminated cooking liquid to move upwards within the cooking receptacle and so drives this debris-contaminated cooking liquid towards the inlet guide of the cleaning device.

In addition, the warmer debris-contaminated cooking liquid is replaced by cooler debris-contaminated cooking liquid and so a convective effect is created within the cooking receptacle which further assists in dislodging debris from the bottom of the said cooking receptacle.

There now follows a brief description of preferred embodiments of the invention, by way of non-limiting example, with reference being made to the following figures in which:

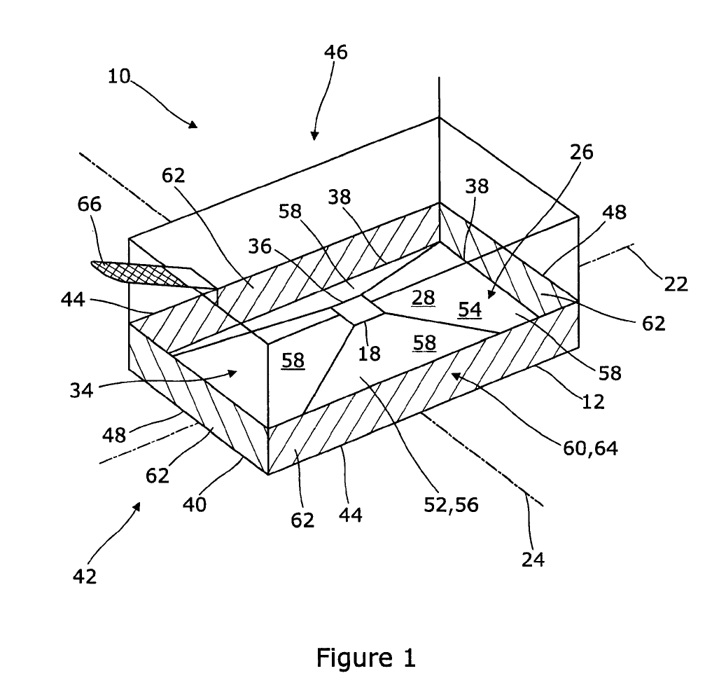

FIG. 1 shows a perspective view of a cleaning device according to a first embodiment of the invention;

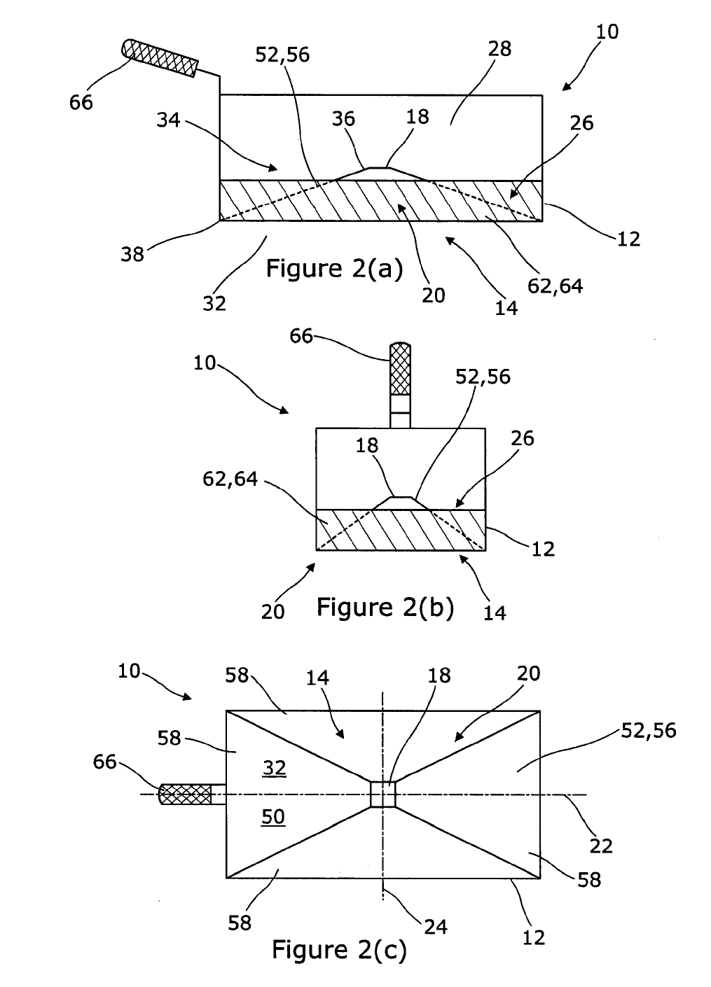

FIG. 2(a) shows an elevational view from a first side of the cleaning device shown in FIG. 1;

FIG. 2(b) shows a front elevational view of the cleaning device shown in FIG. 1;

FIG. 2(c) shows a plan view from below of the cleaning device shown in FIG. 1; and

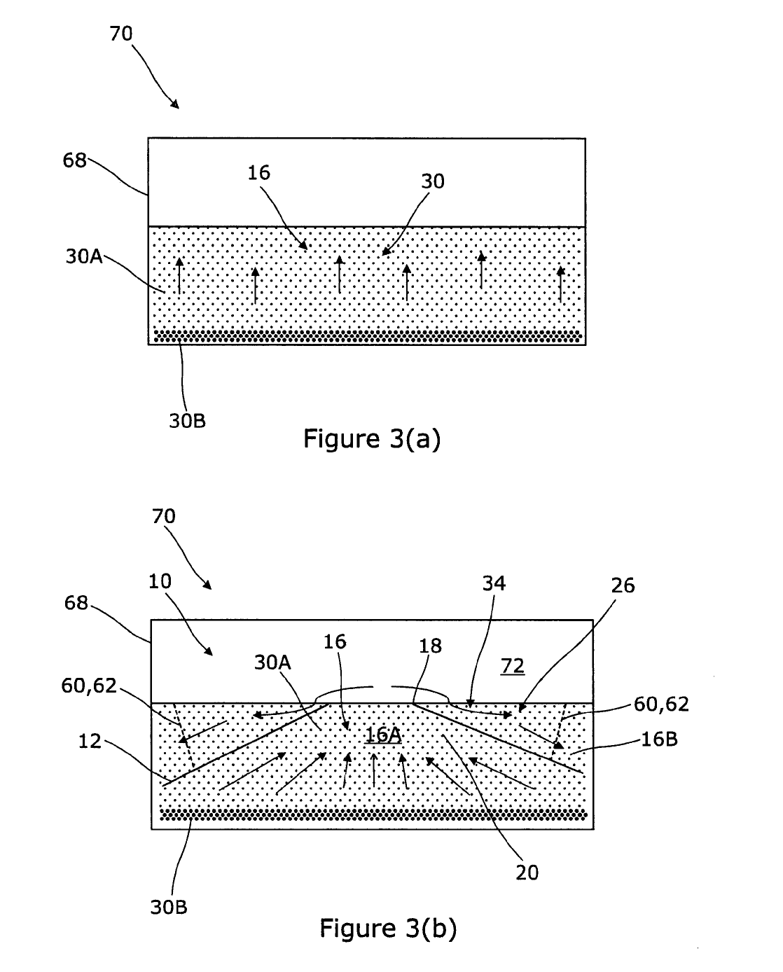

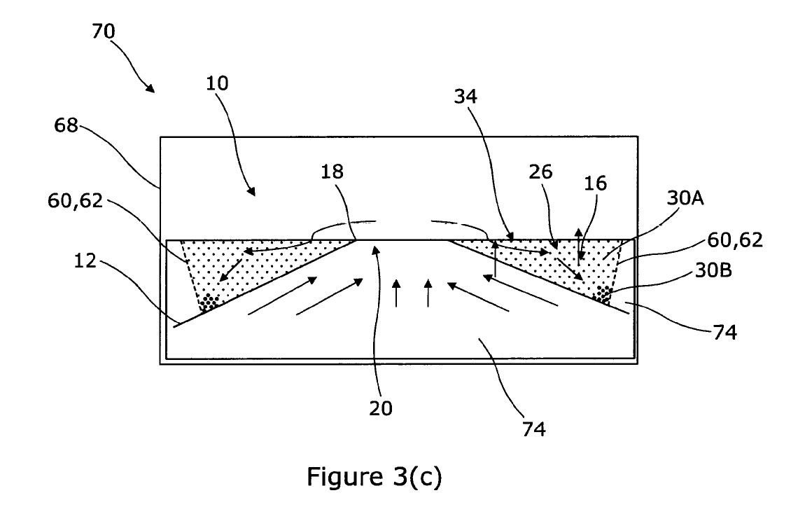

FIGS. 3(a) to 3(c) illustrate respective stages in the use of the cleaning device shown in FIG. 1.

A cleaning device according to a first embodiment of the invention is designated generally be reference numeral 10 as shown, for example, in FIG. 1.

The cleaning device 10 includes a cleaning body 12 which has an inlet 14 to receive debris-contaminated cooking liquid 16. More particularly, the inlet includes an inlet aperture 18 from which extends an inlet guide 20. The inlet guide 20 narrows towards the inlet aperture 18 to, in use, urge the aforementioned debris-contaminated cooking liquid 16 towards the inlet aperture 18.

In the embodiment shown the inlet guide 20 extends completely around the inlet aperture 18 in a symmetrical manner which, in the embodiment shown, is defined by respective first and second axes of symmetry 22, 24 (as shown in FIG. 2(c)). In other embodiments of the invention, however, the inlet guide 20 may have a different configuration, including more than or fewer axes of symmetry as well as also being rotationally symmetrical.

The cleaning body 12 of the cleaning device 10 also includes a cleaning chamber 26 that is arranged on a downstream side 28 of the inlet aperture 18 to separate debris 30, i.e. both small and light debris 30A as well as large and dense debris 30B, from debris-contaminated cooking liquid 16 which is urged into the cleaning chamber 26 by the aforementioned inlet guide 20.

The inlet aperture 18 and the cleaning chamber 26 cooperate with one another to resist the flow of debris-contaminated cooking liquid 16 from the downstream side 28 of the inlet aperture 18 to an upstream side 32 of the inlet aperture 18.

More particularly the cleaning chamber 26 includes a discharge guide 34 that has a first end 36 which lies coincident with the inlet aperture 18. The discharge guide 34 extends away from the inlet aperture 18 and also extends towards the upstream side 32 of the inlet aperture 18 to define a second end 38 of the discharge guide 34.

In addition, the discharge guide 34 extends completely around the inlet aperture 18 in a symmetrical manner which, in the embodiment shown, is defined by the same first and second axes of symmetry 22, 24 mentioned above, i.e. as shown in FIG. 1. In this manner the second end 38 of the discharge guide 34 defines a rectangular perimeter 40 that has a first pair 42 of equal-length long sides 44 and a second pair 46 of equal-length short sides 48, but could also in other embodiments of the invention have single-length equal sides, i.e. could also define a square perimeter.

In still further embodiments of the invention the discharge guide 34 may have a different configuration to that described above, including having more than or fewer axes of symmetry as well as also being rotationally symmetrical.

Returning to the embodiment shown, a first side 50 of a body member 52 defines the inlet guide 20 and a second side 54 of the body member 52 defines the discharge guide 34. More particularly the body member 52 is a planar member 56 that is formed from four planar member panels 58, each of which in the embodiment shown has a substantially frusto-triangular shape. Fewer than or more than four planar member panels are also possible however, as are differently shaped planar member panels 58.

The cleaning chamber 26 includes a filter member 60 that is arranged towards the second end 38 of the discharge guide 34. More particularly, in the embodiment shown, the filter member 60 is arranged at the second end 38 of the discharge guide 34 although this need not necessarily be the case.

The filter member 60 includes a mesh 62, and more particularly a wire mesh 62 which is upstanding from the discharge guide 34. Other forms of filter member, such as for example, gauze or other fabric filters, felts, paper, plastic meshes or microporous membranes, may also be used. In the embodiment shown the filter member 60, i.e. the wire mesh 62, is upstanding from the second end 38 of each planar member panel 58 so as to define a rectangular upstanding fence 64 around the entire perimeter 40 of the discharge guide 34.

In addition to the foregoing, the cleaning body 12 includes a handle 66 fixedly secured thereto to help a user insert and remove the cleaning device 10 from a cooking receptacle, e.g. a cooking tank 68, of a liquid-based cooking apparatus 70, as shown for example in FIGS. 3(b) and 3(c).

In use, the user inserts the cleaning device 10 into the cooking receptacle, i.e. the cooking tank 68, of the liquid-based, e.g. cooking oil-based, cooking apparatus 70 with the inlet guide 20 of the cleaning device 10 extending below the inlet aperture 18, i.e. with the inlet guide 20 lying lowermost in the cooking tank 68.

The user then drives debris-contaminated cooking liquid 16 towards the inlet guide 20 whereby the inlet guide 20 urges the debris-contaminated cooking liquid 16 through the inlet aperture 18. One way in which the user may drive debris-contaminated cooking liquid 16 towards the inlet guide 20 is by increasing the temperature of the cooking liquid 16, and more particularly, by way of example, by increasing the cooking liquid 16 from a blanching temperature of around 80° C. to a cooking temperature of around 180° C.

This causes warmer debris-contaminated cooking liquid 16A to move upwards (since it is less dense than nearby cooler cooking liquid 16B) within the cooking tank 66 towards the inlet guide 20, as illustrated schematically in FIG. 3(a).

The narrowing of the of the inlet guide 20 towards the inlet aperture 18 increases the velocity of the warmer debris-contaminated cooking liquid 16A as it is forced through the inlet aperture 18 and so carries smaller debris 30A suspended in the debris-contaminated cooking liquid 16 through the inlet aperture 18 and into the cleaning chamber 26 lying therebeyond, e.g. as shown in FIG. 3(b).

Such an increase in the velocity of the warmer debris-contaminated cooking liquid 16A also dislodges and entrains larger debris 30B into the flow of debris-contaminated cooking liquid 16 entering the cleaning chamber 26 via the inlet aperture 18.

As the debris-contaminated cooking liquid 16 passes through the inlet aperture 18 it is exposed to ambient air 72 in the cooking environment and so cools. This cooling of the debris-contaminated cooking liquid 16 causes it to flow naturally down over the discharge guide 34 towards the filter member 60, i.e. the wire mesh 62 which is upstanding from the second end 38 of the discharge guide 34. In this way the discharge guide 34 is shaped to both capture and retain the debris-contaminated cooking liquid 16 forced into the cleaning chamber 26, as well as direct the debris-contaminated cooking liquid 16 to a region of the cleaning chamber 26 which separates the debris 30A, 30B from the debris-contaminated cooking liquid 16, i.e. towards the filter member 60.

In the meantime, the convective flow established by the warming and cooling of the debris-contaminated cooking liquid 16 further assists in dislodging and entraining debris 30A, 30B in the debris-contaminated cooking liquid 16 forced through the inlet aperture 18 into the cleaning chamber 26.

The filter member 60, i.e. the wire mesh 62, catches the debris 30A, 30B entrained in the debris-contaminated cooking liquid 16 urged into the cleaning chamber 26, as shown in FIG. 3(c). This permits substantially uncontaminated, i.e. substantially clean, cooking liquid 72 to flow out of the cleaning device 10.

1. A cleaning device, for a liquid-based cooking apparatus, comprising a cleaning body including:
an inlet to receive debris-contaminated cooking liquid, the inlet having an inlet aperture from which extends an inlet guide, the inlet guide narrowing towards the inlet aperture to in use urge debris-contaminated cooking liquid through the inlet aperture; and
a cleaning chamber arranged on a downstream side of the inlet aperture to separate debris from debris-contaminated cooking liquid urged thereinto by the inlet guide.

2. A cleaning device according to claim 1 wherein the inlet guide extends completely around the inlet aperture.

3. A cleaning device according to claim 2 wherein the inlet guide extends symmetrically around the inlet aperture.

4. A cleaning device according to claim 1 wherein the inlet aperture and cleaning chamber cooperate with one another to resist the flow of debris-contaminated cooking liquid from the downstream side of the inlet aperture to an upstream side thereof.

5. A cleaning device according to claim 4 wherein the cleaning chamber includes a discharge guide having a first end lying coincident with the inlet aperture, the discharge guide extending away from the inlet aperture and towards the upstream side of the inlet aperture to define a second end of the discharge guide.

6. A cleaning device according to claim 5 wherein the discharge guide extends completely around the inlet aperture.

7. A cleaning device according to claim 6 wherein the discharge guide extends symmetrically around the inlet aperture.

8. A cleaning device according to claim 7 wherein the second end of the discharge guide defines a rectangular perimeter.

9. A cleaning device according to claim 5 wherein a first side of a body member defines the inlet guide and a second side of the body member defines the discharge guide.

10. A cleaning device according to claim 9 wherein the body member is or includes a planar member.

11. A cleaning device according to claim 10 wherein the planar member is formed from a plurality of planar member panels.

12. A cleaning device according to claim 5 wherein the cleaning chamber includes a filter member arranged towards the second end of the discharge guide.

13. A cleaning device according to claim 12 wherein the filter member is or includes a mesh upstanding from the discharge guide.

14. A method of cleaning a liquid-based cooking apparatus including a cooking receptacle that in use receives and retains a cooking liquid, comprising the steps of:
(a) inserting a cleaning device according to any preceding claim into the cooking receptacle with the inlet guide of the cleaning device extending below the inlet aperture;
(b) driving debris-contaminated cooking liquid towards the inlet guide whereby the inlet guide urges the debris-contaminated cooking liquid through the associated inlet aperture; and
(c) separating in a cleaning chamber of the cleaning device debris from debris-contaminated cooking liquid urged into the cleaning chamber by the inlet guide.

15. A method of cleaning a liquid-based cooking apparatus according to claim 14 wherein step (b) of driving debris-contaminated cooking liquid towards the inlet guide includes increasing the temperature of the cooking liquid.
